(19) United States
(12) Patent Application Publication
(10) Pub. No.: US 2024/0250437 A1
(43) Pub. Date: Jul. 25, 2024

(54) THIN SHEET-LIKE ANTENNA FOR NARROWBAND VEHICULAR COMMUNICATION

(71) Applicant: FORD GLOBAL TECHNOLOGIES, LLC, Dearborn, MI (US)

(72) Inventor: Eric Newsom, Frankenmuth, MI (US)

(21) Appl. No.: 18/100,105

(22) Filed: Jan. 23, 2023

(51) Int. Cl. H01Q 9/20; H01Q 1/32; H01Q 1/48

(52) U.S. Cl. CPC H01Q 9/20; H01Q 1/3283; H01Q 1/48

(57) ABSTRACT

A tuned dipole antenna is adapted for use in cellular vehicle-to-everything (C-V2X) communication. A first substrate is provided which includes a conductive ground plane layer on a lower surface of a first dielectric layer, a plurality of conductive patches in an array on an upper surface of the first dielectric layer, and a plurality of conductive vias through the first dielectric layer connecting the conductive patches to the ground plane layer. A second substrate is juxtaposed with the upper surface of the first substrate. First and second dipole antenna elements are disposed on the second substrate and configured to be coupled to an RF transmission line. A thin antenna structure is obtained which can be mounted conformally onto exterior surfaces of a vehicle.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to planar antenna structures for mounting on vehicles, and, more specifically, to a narrowband antenna providing a thin, conformal unit with a radiation pattern oriented orthogonal to the plane of the antenna.

Wireless communication is becoming increasingly important in the operation of transportation vehicles such as cars and trucks. In particular, advanced driver assistance systems and autonomous vehicle systems may utilize wireless communication with nearby vehicles, roadside transceivers, remote base stations, and satellites. Thus, antenna systems represent a significant impact on parts cost, manufacturing/assembly cost, and packaging cost.

Some antennas have been formed as metal traces on the windows of the vehicle, and although on-glass antennas conform to the surface of the vehicle they have provided limited performance (e.g., poor directionality) and are not capable of being used for all of the various radio services. Other types of antenna elements such as masts or “shark fin” antennas which protrude from the surface and can detract from the look of a vehicle. Moreover, they may be subject to damage from being struck by other objects (e.g., in a car wash). The designs, shape, size, and placement of various antennas may be dictated by aspects of the radio signal properties of the respective wireless service to be transmitted.

Various standards have been adopted for many of the wireless services being used in intelligent vehicular transportation systems. Vehicle-to-Everything (V2X) systems refers to any wireless communications which may involve a vehicle. V2X includes vehicle-to-vehicle (V2V) communication where vehicles share information with each other, vehicle-to-infrastructure (V21) communication where vehicles share information with the infrastructure, vehicle-to pedestrian (V2P) communication where vehicles and/or the infrastructure share information with other travelers. One important type of V2X system for intelligent transportation is the Cellular Vehicle-to-Everything (C-V2X) standard, which may typically operate at 5.9 GHz (e.g., a spectrum of 5.850 GHz to 5.925 GHz).

In a C-V2X application, signals propagate to and from the vehicle generally horizontally (e.g., by line of sight). In view of the wavelengths of the signals, conventional antenna structures have had a horizontal thickness of 25 millimeters or more, which is undesirable for placement on vertical surfaces (e.g., front grille, windows, or rear tailgate) for styling and other reasons because of the protrusion. Placement on a horizontal roof is undesirable for the same reasons and because the presence of a sheet metal panel of the roof causes the main direction of propagation to reflect upward (e.g., by 20°) thereby reducing the horizontal performance.

Thus, it would be advantageous to provide a compact antenna which is conformal to a vehicle surface (i.e., has thin, low-profile form factor), which is effective over a relatively narrow bandwidth (e.g., the 5.9 GHz band for C-V2X), and which can be mounted on any type of metal or nonmetal surface on the exterior of a vehicle.

### SUMMARY OF THE INVENTION

In one aspect of the invention, a tuned dipole antenna is provided which comprises a first substrate with a conductive ground plane layer on a lower surface of a first dielectric layer, a plurality of conductive patches in an array on an upper surface of the first dielectric layer, and a plurality of conductive vias through the first dielectric layer connecting the conductive patches to the ground plane layer. A second substrate is juxtaposed with the upper surface of the first substrate. First and second dipole antenna elements are disposed on the second substrate and configured to be coupled to an RF transmission line.

### BRIEF DESCRIPTION OF THE DRAWINGS

FIG. 1 is a perspective view of an antenna according to an embodiment of the invention.

FIG. 2 is a partially exploded view of the antenna of FIG. 1.

FIG. 3 is a partially exploded view of a meta-material portion of the antenna shown in FIG. 2.

FIG. 4 is a partially exploded view showing the antenna of FIG. 1 with an overwrap and a subminiature connector.

FIG. 5 is a side, cross-sectional view of a region of the antenna at the dipole antenna elements.

FIG. 6 is a perspective view of the dipole antenna elements and connections.

FIG. 7 is a side view of the elements shown in FIG. 6.

FIG. 8 is a top view of a vehicle with an exterior surface carrying an antenna according to the present invention.

FIG. 9 is a schematic diagram showing an antenna radiation pattern for an antenna mounted on a rear, vertical surface of a vehicle.

### DETAILED DESCRIPTION OF PREFERRED EMBODIMENTS

A tuned antenna according to a preferred embodiment of the invention employs a meta-material which is a dielectric board with one side completely metalized and acting as the ground plane and the other side having a periodic array of square patches. A via located at the center of each of these patches connects the patch to the ground plane. The resulting periodic structure of “mushrooms” act as a high impedance surface that suppresses RF currents over a select narrow frequency band and which does not undergo any 180° phase flip in reflections. The size and shape of the patches, the size and shape of the vias, and thickness of the dielectric are all designed to resonate at the frequency of interest (e.g., 5.9 GHZ). The capacitance of the patches need to be balanced with the inductance of the dielectric thickness, which can be chosen to correspond with commercial, off-the-shelf laminates (e.g., RT/Duroid® 5880 laminate available from Rogers Corporation of Chandler, Arizona). On top of the meta-material surface an additional substrate is provided with dipole antenna elements formed as a top layer (tuned to the meta-material and configured to meet the gain and impedance requirements of the antenna). In particular, the dipole is configured to obtain excellent horizontal gain performance.

As a result, a thin planar antenna is obtained which is so thin that it can be integrated as an applique for placement onto a surface of a vehicle essentially as a sticker. The antenna can easily be placed on a vertical surface (e.g., tailgate, grilles, fenders, liftgates, windows) without negatively impacting the esthetic appearance of the vehicle, while also optimizing the directionality of the antenna (e.g., horizontal to the road surface). The applique may include an adhesive backing to allow for integration on any surface. The vehicle surface can be any material (conductive or nonconductive) since the laminated antenna includes its own ground plane.

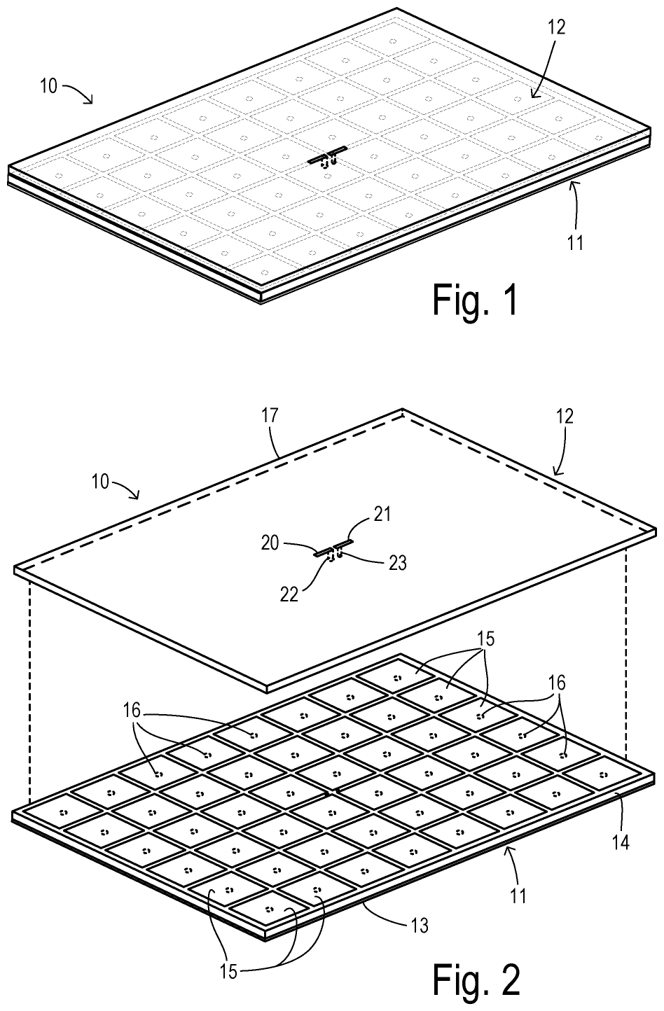

Referring to FIGS. 1 and 2, a laminated antenna structure 10 has a first substrate 11 and a second substrate 12 which is juxtaposed on first substrate 11. A conductive ground plane layer 13 is provided on a lower surface of a first dielectric layer 14. A plurality of conductive patches 15 form an array disposed across an upper surface of first dielectric layer 14. A plurality of conductive vias 16 extend through first dielectric layer, each connecting a respective one of conductive patches 15 to ground plane layer 13. Second substrate 12 has a second dielectric layer 17 without any conductive layer on its lower surface so that it can rest against the upper surface of first substrate 11. First and second dipole antenna elements 20 and 21 disposed on an upper surface of second dielectric layer 17. A signal via 22 connects to first dipole antenna element 20 and passes through substrates 11 and 12 to make available an antenna feed. A grounding via 23 passes through substrates 11 and 12 to connect second dipole antenna element 21 to ground plane layer 13. Vias 22 and 23 may each include two halves which are axially aligned in dielectric layers 14 and 17 and which are located in a gap between conductive patches 15. Consequently, first and second dipole antenna elements 20 and 21 are also aligned with the gap.

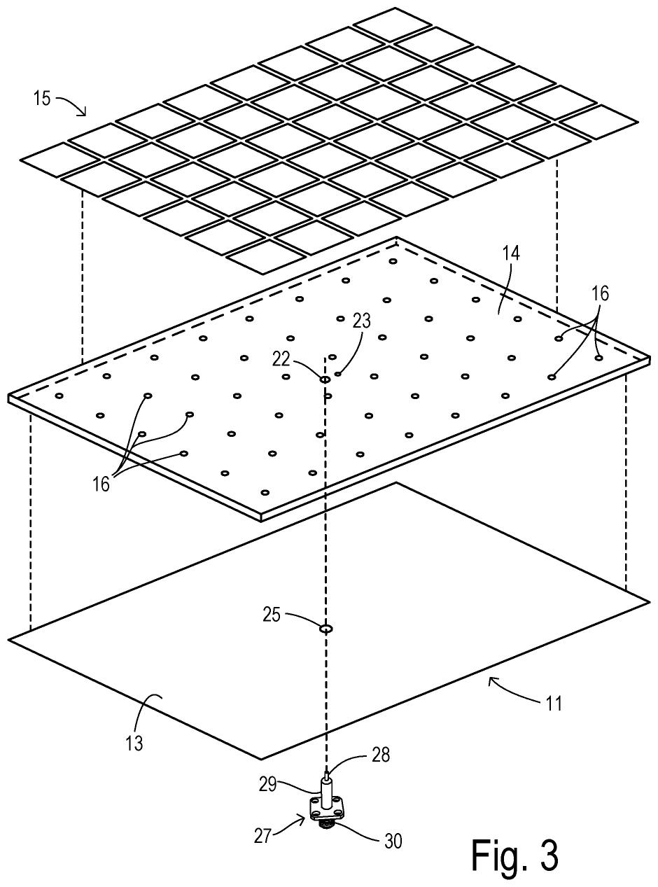

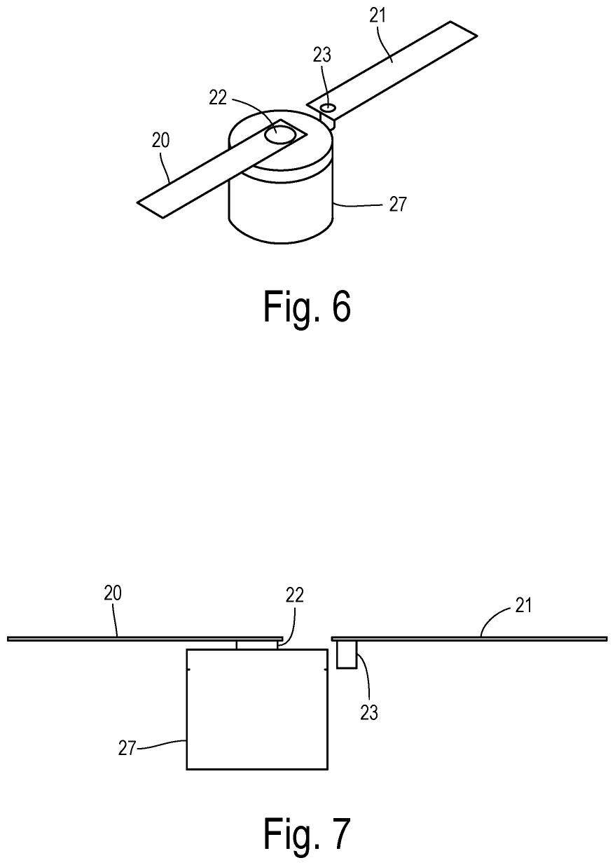

FIG. 3 shows an exploded view of substrate 11, revealing the lower halves of vias 22 and 23. An opening 25 is provided in ground plane layer 13 for accessing signal via 22. A coaxial connector body 27 has a signal conductor 28 for connecting to first dipole antenna element 20 through signal via 22. Connector body 27 a shield conductor portion 29 for connecting to second dipole antenna element 21 and/or ground plane layer 13. A subminiature female socket on connector body 27 is adapted to connect with a coaxial transmission cable to feed antenna signals to a transceiver in the vehicle. The arrangement of dipole antenna elements 20 and 21, connector body 27, and vias 22 and 23 are shown in greater detail in FIGS. 5-7.

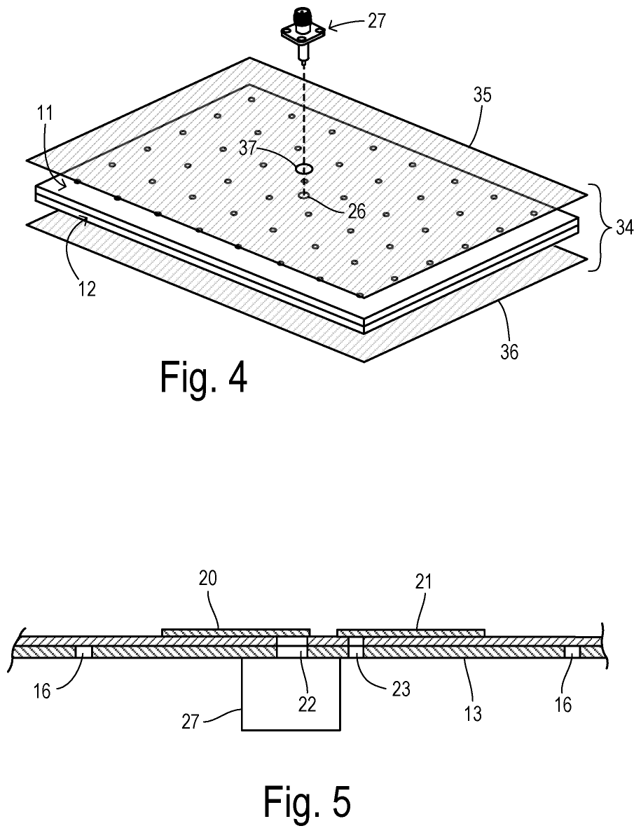

FIG. 4 shows an overwrap 34 comprised of thin, flexible sheets 35 and 36 for enclosing substrates 11 and 12. Preferably, sheet 35 is a backing sheet coated with an adhesive on an outer surface for applying as an applique on an exterior vehicle surface. The inner surfaces of sheets 35 and 36 may also include adhesive for joining as an integrated unit. Sheets 35 and 36 may comprise thermoplastic or other vehicular trim material which can be colored or decorated for styling purposes. Sheet 35 includes an aperture 37 for accommodating coaxial connector body 27 and/or a transmission cable or other signal feed exiting the antenna.

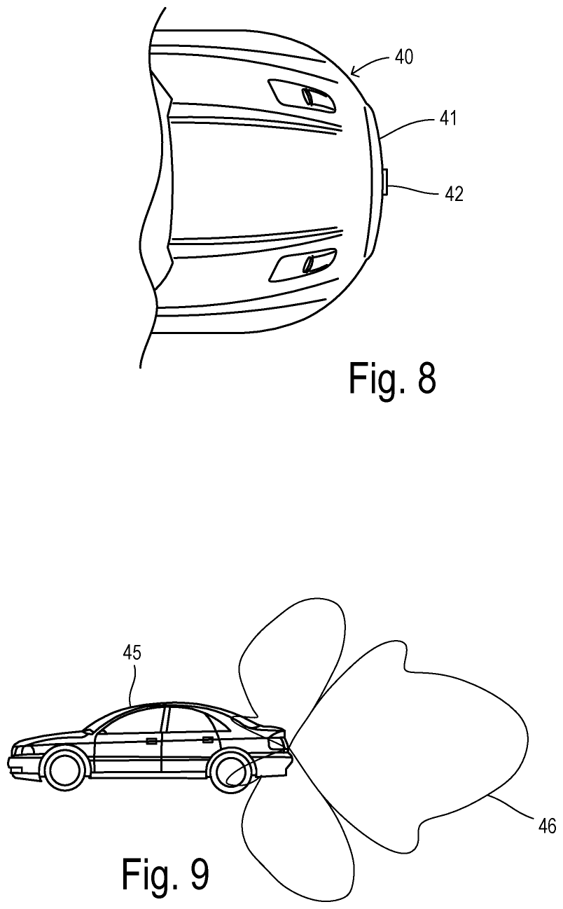

FIG. 8 shows a vehicle 40 have a vertical exterior surface 41 (e.g., a front grille) carrying an antenna 42 formed as an applique according to the above embodiments. Using the disclosed features, antenna 42 can be constructed having a total thickness (i.e., standoff from the vehicle surface) of less than 1 millimeter. By using thin laminated substrates (e.g., PTFE dielectric material with thin copper coating), a flexible applique is obtained which can conform to curved vehicle surfaces. FIG. 9 shows another vehicle 45 with an antenna mounted to a rearward facing vertical surface, such as a rear bumper. By enabling placement on a vertical surface and by configuring the planar antenna with a radiation pattern directed perpendicular to the plane of the antenna, an optimally horizontal radiation pattern 46 is obtained.

To adapt an antenna of the invention to operating at a 5.9 GHz band, the following dimensions have been demonstrated. Rogers 5880 dielectric layers were used for both substrates with a rectangular shape. The length of one side of the sheets may be in a range from about 5 to 6 inches, and the length of the other side may be in a range from about 4 to 4.5 inches (e.g., preferred dimensions of about 5.5 inches by 4.15 inches). The meta-material substrate had a thickness of 0.020 inches (including attached copper layers for the ground plane and patches) and the dipole antenna substrate had a thickness of 0.010 inches. For use at 5.9 GHZ, the dielectric thickness should be less than or equal to 1 millimeter. An 8 by 6 array on the meta-material substrate was comprised of square patches with each edge in a range of from 0.5 to 0.8 inches (e.g., about 0.629 inches). For operation in the 5.9 GHz band, a square for each patch should be less than or equal to 1 inch. A gap between adjacent patches in preferably in a range from about 0.06 to 0.1 inches. The conductive vias between the patches and the ground plane layer had a radius of 0.010 inches, with a preferred range of 05. to 0.15 inches.

To fabricate an antenna, laminated dielectric layers which are initially provided with through-holes at positions specified for the vias and then cladded on both sides with copper which can be etched as needed. Alternatively, vias can be drilled and filled at a later time when the etching is performed. A lower side of the lower dielectric (meta-material) is etched only for an aperture for the antenna feed. The upper side of the lower dielectric is etched to form the conductive patches so as to place the vias at their geometric centers. For the upper dielectric (dipole antenna), copper cladding is completely etched away on the lower side, and the dipole antenna elements are etched on the upper side. After attaching a coaxial connector, the unit can be covered with an overwrap with the desired characteristics for integrating with a vehicle.

What is claimed is:

1. A tuned dipole antenna comprising:
a first substrate with a conductive ground plane layer on a lower surface of a first dielectric layer, a plurality of conductive patches in an array on an upper surface of the first dielectric layer, and a plurality of conductive vias through the first dielectric layer connecting the conductive patches to the ground plane layer;
a second substrate juxtaposed with the upper surface of the first substrate; and
first and second dipole antenna elements disposed on the second substrate wherein the first and second dipole antenna elements are configured to be coupled with an RF transmission line.

2. The antenna of claim 1 wherein the second dipole antenna element is connected to the ground plane layer.

3. The antenna of claim 2 wherein the second substrate comprises a second dielectric layer, wherein the first and second dipole antenna elements are disposed on an upper surface of the second dielectric layer, wherein a lower surface of the second dielectric layer lies against the first substrate, and wherein the antenna further comprises a grounding via formed through the first substrate and the second substrate respectively to connect the second dipole antenna element to the ground plane layer.

4. The antenna of claim 1 further comprising a coaxial connector body adapted to connect with a coaxial transmission cable and having a signal conductor coupled to the first dipole antenna element and having a shield conductor coupled to the second dipole antenna element.

5. The antenna of claim 1 wherein the ground plane layer, a thickness of the first dielectric layer, a size of each of the conductive patches, and a gap distance between adjacent ones of the conductive patches are configured to form a meta-material body which is resonant in a frequency band for an intelligent vehicular transportation system.

6. The antenna of claim 5 wherein the intelligent vehicular transportation system comprises communications according to a cellular vehicle-to-everything (C-V2X) communication standard.

7. The antenna of claim 1 wherein the conductive patches are substantially square plates with each side less than or equal to one inch, wherein gaps between adjacent conductive patches in the array are each greater than or equal to 0.06 inches, and wherein a thicknesses of the first dielectric layer is less than or equal to 1 millimeter, so that a meta-material body is formed which is resonant at 5.9 GHz.

8. The antenna of claim 7 wherein the conductive vias each comprise a cylindrical conductor member having a radius in a range of 0.05 to 0.15 inches, and wherein each via connects to a respective conductive patch at a geometric center of the respective conductive patch.

9. The antenna of claim 1 further comprising an adhesive backing layer configured to conformally mount the antenna onto an exterior surface of a transportation vehicle.

10. A narrowband antenna for cellular vehicle-to-everything (C-V2X) communication, comprising:
a first substrate with a conductive ground plane layer on a lower surface of a first dielectric layer, a plurality of conductive patches in an array on an upper surface of the first dielectric layer, and a plurality of conductive vias through the first dielectric layer connecting the conductive patches to the ground plane layer;
a second substrate juxtaposed with the upper surface of the first substrate; and
first and second dipole antenna elements disposed on the second substrate;
a connector body adapted to couple the first dipole antenna element and the second dipole antenna element with a transmission cable; and
an overwrap covering the first and second substrates and configured to mount onto an exterior surface of a transportation vehicle.

11. The narrowband antenna of claim 10 wherein the second dipole antenna element is connected to the ground plane layer.

12. The narrowband antenna of claim 11 wherein the second substrate comprises a second dielectric layer, wherein the first and second dipole antenna elements are disposed on an upper surface of the second dielectric layer, wherein a lower surface of the second dielectric layer lies against the first substrate, and wherein the narrowband antenna further comprises a grounding via formed through the first substrate and the second substrate respectively to connect the second dipole antenna element to the ground plane layer.

13. The narrowband antenna of claim 10 wherein the connector body is comprised of a coaxial connector body adapted to connect with a coaxial transmission cable.

14. The narrowband antenna of claim 10 wherein the ground plane layer, a thickness of the first dielectric layer, a size of each of the conductive patches, and a gap distance between adjacent ones of the conductive patches are configured to form a meta-material body which is resonant in a frequency band for an intelligent vehicular transportation system.

15. The narrowband antenna of claim 14 wherein the frequency band includes 5.9 GHZ.

16. The narrowband antenna of claim 15 wherein the conductive patches are substantially square plates with each side less than or equal to one inch, wherein gaps between adjacent conductive patches in the array are each greater than or equal to 0.06 inches, and wherein a thicknesses of the first dielectric layer is less than or equal to 1 millimeter.

17. The narrowband antenna of claim 16 wherein the conductive vias each comprise a cylindrical conductor member having a radius in a range of 0.05 to 0.15 inches, and wherein each via connects to a respective conductive patch at a geometric center of the respective conductive patch.

18. The narrowband antenna of claim 10 wherein the overwrap comprises an adhesive backing layer configured to conformally mount the narrowband antenna onto the exterior surface.
